(19) United States
(12) Patent Application Publication
(10) Pub. No.: US 2003/0180049 A1
(43) Pub. Date: Sep. 25, 2003

(54) Wavelength division multiplexing passive optical network system

(76) Inventor: Tae-Sung Park, Suwon-shi (KR)

Correspondence Address: CHA & REITER, 411 HACKENSACK AVE, 9TH FLOOR, HACKENSACK, NJ, 07601, US

(21) Appl. No.: 10/382,704

(22) Filed: Mar. 6, 2003

(30) Foreign Application Priority Data
Mar. 21, 2002 (KR) 2002-15251

(51) Int. Cl. H04J 14/02

(52) U.S. Cl. 398/72; 398/82

(57) ABSTRACT

A wavelength division multiplexing passive optical network system is disclosed. The system includes a fiber transfer end for transmitting downstream optical signals through a fiber. The downstream optical signals are obtained by performing wavelength division multiplexing on downstream channels having different wavelengths from one another. The fiber transfer end also demultiplexes upstream optical signals received through the fiber. The upstream optical signals are include a first and a second upstream channels having different wavelengths from one another. The system also includes a power splitter for performing a uniform power split on the downstream optical signals received through a first port that is connected to the fiber, and for outputting the split optical signals through a plurality of second ports, and for outputting upstream optical signals through the first port. The upstream optical signals are a combination of the first and the second upstream channels received from the plurality of second ports. The system also includes a plurality of optical network elements for demultiplexing the downstream optical signals from a second port of an optical divider by wavelengths, and for transmitting the first and the second upstream channels to the optical divider.

### CLAIM OF PRIORITY

This application claims priority to an application entitled “Wavelength Division Multiplexing Passive Optical Network System” filed in the Korean Industrial Property Office on Mar. 21, 2002 and assigned Serial No. 02-15251, the contents of which are hereby incorporated by reference.

### BACKGROUND OF THE INVENTION

1. Field of the Invention

The present invention relates generally to passive optical network, and more particularly, to a wavelength division multiplexing passive optical network system.

2. Description of the Related Art

A variety of network configurations, e.g., xDSL (x-Digital Subscriber Line), HFC (Hybrid Fiber Coax), FTTB (Fiber To The Building), FTTC (Fiber To The Curb), or FTTH (Fiber To The Home) have been suggested for the configuration of subscriber networks from a central office to a customer premise environment, e.g., buildings and homes.

Implementation of those FTTx (i.e., FFTB, FTTC, FTTH) can be divided into two categories; (1) an active FTTx with an active optical network (AON) and (2) a passive FTTx with a passive optical network (PON). The passive optical network, because of a point-to-multipoint topology through passive elements, is expected to be a future optical subscriber network having a good economic value.

In general, the passive optical network is a subscriber network configuration forming a tree-shaped distributed topology. A plurality of optical network units (ONU) are connected to an optical line termination (OLT) using a1×N passive power splitter. The ITU-T (International Telecommunication Union-Telecommunication sect) has promulgated standards on ATM-PON (Asynchronous Transfer Mode-Passive Optical Network) system as ITU-T.G982, ITU-T.G983.1, and ITU-T.G.983.3. In addition, IEEE802.3ah TF (Institute of Electrical and Electronics Engineers) is working on standardization of a Gigabit Ethernet based passive optical network system.

Work regarding the transmission capacity in the ATM-PON system and Ethernet-passive optical network system is also being discussed in the international standard organizations like the ITU-T and IEEE802.3. The transmission capacity is usually dependent on the data format being loaded on two different wavelengths between a fiber transfer end and an optical network element. In this regard, the international standard organizations (e.g., ITU-T and IEEE802.3), are considering a 1550 nm (or 1490 nm) and a 1310 wavelengths for these two different wavelengths. The downstream transmission from a fiber transfer end of the central office to a subscriber's optical network element would involve loading asynchronous transfer mode cell (ATM cell) or Ethernet frame on a 1550 nm (or 1490 nm) wavelength-signal, while the upstream transmission from a fiber transfer end of the central office to a subscriber's optical network element would involve loading data on a 1310 nm wavelength-signal.

FIG. 1 is a diagram representing wavelength allocation of ATM-PON system, which is regulated by ITU-T. Particularly, the drawing illustrates an upstream wavelength band 110 and downstream wavelength bands 120 and 130.

For the upstream wavelength band 110, a wavelength band in the range between 1260 nm to 1360 nm is allocated for optical signals progressing from an optical network element to a fiber transfer end.

For the downstream wavelength bands 120 and 130, a wavelength band in the range between 1480 nm to 1500 nm and a wavelength band in the range of from 1539 nm to 1565 nm, respectively, are allocated to the downstream wavelength bands 120 and 130 for optical signals progressing from a fiber transfer end to an optical network element. The wavelength band in the range of 1539 nm-1565 nm is called a digital service wavelength band 130, and 1550 nm-1560 nm wavelength band 140 contained within the digital service wavelength band 130 is reserved for digital image signals.

FIG. 2 is a schematic diagram of a conventional passive optical network system. The passive optical network system includes a fiber transfer end 210, a fiber 250, a power splitter (PS) 260, and n-optical network elements 270 (denoted as ONU₁ through ONU_{N}).

The fiber transfer end 210 includes an optical transmitter (Tx) 220, an optical receiver (Rx) 240, and an optical divider 230.

The optical transmitter 220 includes a laser diode (LD) (not shown)that is used to output downstream channels having a wavelength of either 1550 nm or 1490 nm.

The optical receiver 240 typically includes a photodiode that is used convert 1310 nm-wavelength upstream channels, which have been inputted through a third port of the optical divider 230, to electric signals before outputting the same.

A 1×2 wavelength division multiplexer (WDM) is typically used for the optical divider 230. The optical divider 230 outputs the downstream channels that are inputted through a first port to a second port, and then outputs the upstream channels that are inputted through the second port to a third port. In FIG. 2, the second port is connected to the fiber 250.

A 1×n power splitter is typically used for the power splitter 260. The power splitter 260 performs a uniform power split on the downstream channels inputted through the fiber 250, and then outputs the split channels to the n optical network elements 270.

Each of the n-optical network elements 270 include an optical divider 280, an optical receiver 290, and an optical transmitter 300.

A 1×2 wavelength division multiplexer (WDM) is typically used for the optical divider 280. The optical divider 280 outputs the downstream channels that are inputted through a first port connected to the fiber 250 to a second port, and it outputs the upstream channels that are inputted through a third port to the second port.

The optical receiver 240 typically includes a photodiode. The optical receiver 240 converts the downstream channels having a wavelength of 1550 nm or 1490 nm, which have been inputted through the third port of the optical divider 230, to electric signals before outputting the same.

The optical transmitter 300 typically includes a laser diode (LD). The optical transmitter 300 outputs the upstream channels with a wavelength of 1550 nm or 1490 nm.

The transmission capacity of upstream and downstream channels may be increased following an increase in bandwidth usage by the subscriber side in the ATM-PON system and Ethernet-passive optical network system, by increasing the transfer speed per channel. This approach is being discussed in the ITU-T and the IEEE802.3 organizations. However, this approach has significant shortcomings. For example, the conventional ATM-PON system sets a limit on the data transfer speed, (i.e., 155 Mbps for upstream channels and 622 Mbps for downstream channels). Also, the implementation of the data transfer speed at 1.25 Gbps for both directions in the Ethernet-passive optical network has not been decided upon by any International Standards Organization.

Therefore, there is a need in the art for systems and methods that expand the transmission capacity beyond a maximum transfer speed allowed to every single channel in the passive optical network systems discussed above.

### SUMMARY OF THE INVENTION

The present invention relates to a wavelength division multiplexing passive optical network system.

Another aspect of the present invention is to provide a low priced wavelength division multiplexing passive optical network system

According to one embodiment of the present invention, a wavelength division multiplexing passive optical network system is provided and includes: a fiber transfer end for transmitting downstream optical signals through a fiber. The downstream optical signals are obtained by performing wavelength division multiplexing on downstream channels having different wavelengths from one another, and for demultiplexing upstream optical signals received through the fiber. The upstream optical signals are configured of a first and a second upstream channels having different wavelengths from one another. A power splitter performs a uniform power split on the downstream optical signals received through a first port that is connected to the fiber, and output the split optical signals through a plurality of second ports, as well as outputting upstream optical signals through the first port. The upstream optical signals are combination of the first and the second upstream channels received from the plurality of second ports. The system also includes a plurality of optical network elements for demultiplexing the downstream optical signals from the second port of the power splitter by wavelengths, and for transmitting the first and the second upstream channels to the power splitter.

### BRIEF DESCRIPTION OF THE DRAWINGS

The above and other objects, features and advantages of the present invention will become more apparent from the following detailed description when taken in conjunction with the accompanying drawings in which:

FIG. 1 diagrammatically illustrates wavelength allocation of ATM-PON system, which is regulated by ITU-T;

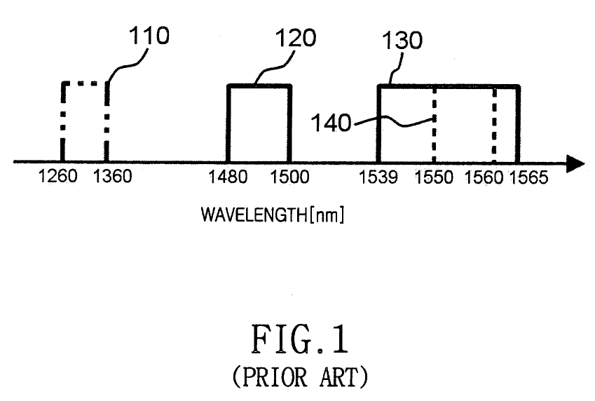

FIG. 2 is a schematic diagram of a conventional passive optical network system;

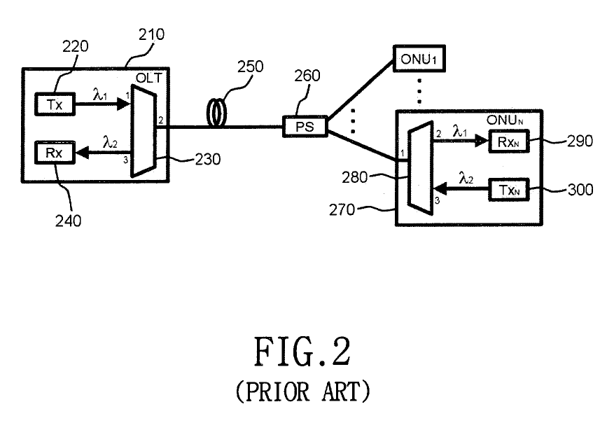

FIG. 3 is a diagram representing wavelength allocation of a passive optical network system in accordance with a preferred embodiment of the present invention;

FIG. 4 is a schematic diagram of the passive optical network system in accordance with the preferred embodiment of the present invention;

FIG. 5 is a diagram showing output characteristic of a fiber transfer end depicted in FIG. 4 against a wavelength division multiplexer;

FIG. 6 is a diagram illustrating output characteristic of a fiber transfer end depicted in FIG. 4 against an optical divider;

FIG. 7 is a diagram illustrating output characteristic of an Nth optical network element depicted in FIG. 4 against a Nth wavelength division multiplexer; and

FIG. 8 is a diagram illustrating output characteristic of an Nth optical network element depicted in FIG. 4 against a (N-1)th wavelength division multiplexer.

### DETAILED DESCRIPTION OF THE PREFERRED EMBODIMENT

A preferred embodiment of the present invention will be described herein below with reference to the accompanying drawings. In the following description, well-known functions, elements, devices or constructions are not described in detail since they would obscure the invention in unnecessary detail.

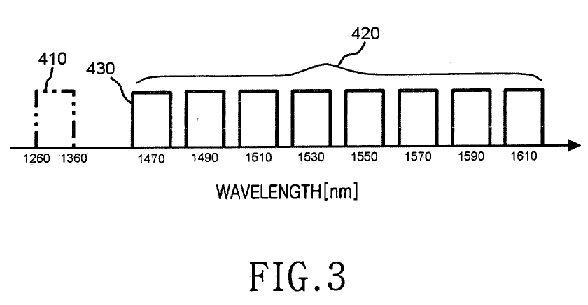

FIG. 3 is a diagram representing wavelength allocation of a passive optical network system in accordance with a preferred embodiment of the present invention. FIG. 3 illustrates an upstream wavelength band 410, and a downstream wavelength 1550 nm (or 1490 nm) and additional bidirectional wavelength band 420.

The wavelength allocated to the upstream wavelength band 410 falls within the range of 1260-1360 nm, and it serves as a wavelength band for optical signals progressing from an optical network element to a fiber transfer end.

A wavelength band in the range of 1470-1610 nm is allocated to the additional bidirectional wavelength band 420. It serves as a wavelength band for optical signals progressing from a fiber transfer end to each optical network element, or from each optical network element to a fiber transfer end. Particularly, 1550 nm-wavelength is allocated for digital image signals. The bidirectional wavelength band 420 includes 8 channels 430 including the 1550 nm-wavelength for digital image signals. The wavelength gap between the channels 430 is approximately 20 nm. The channels 430 include wavelengths of 1470 nm, 1490 nm, 1510 nm, 1530 nm, 1550 nm, 1570 nm, 1590 nm, and 1610 nm.

Due to the broad wavelength gap, the temperature of the optical transmitter (e.g., a laser diode) does not need to be compensated. This means that an inexpensive laser diode can be used as the optical transmitter. In addition, by applying a wavelength division multiplexing method to the additional bidirectional wavelength band 420, the transmission capacity can be greatly expanded.

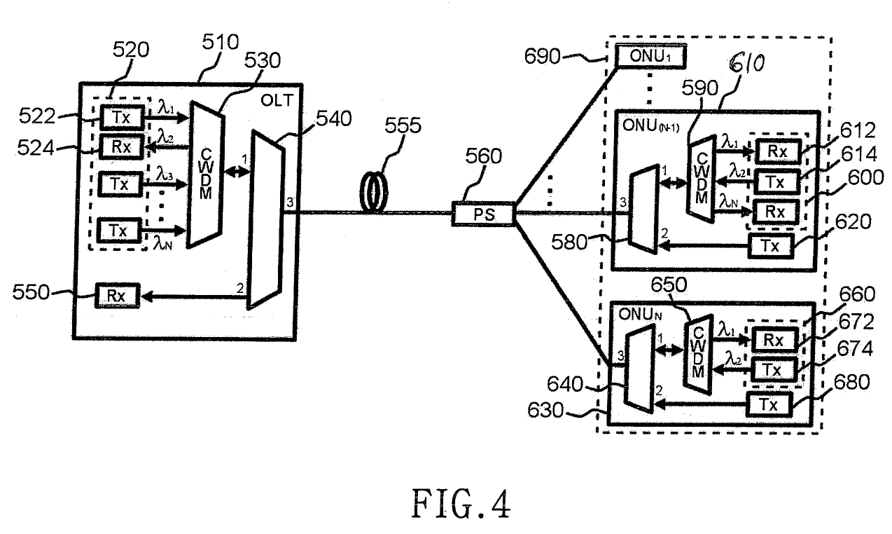

FIG. 4 is a schematic diagram of the passive optical network system in accordance with the preferred embodiment of the present invention. As shown in the FIG. 4, the passive optical network system includes a fiber transfer end 510, a fiber 555, a power splitter 560, and N optical network elements 690.

The fiber transfer end 510 includes an optical transceiver 520, a wavelength division multiplexer 530, an optical divider 540, and a first optical receiver 550.

The optical transceiver 520 includes a plurality of optical transmitters 522 and a second optical receiver 524. Preferably, the optical transmitter 522 includes a laser diode, and the second optical receiver 524 includes a photodiode. Allocated to each optical transmitters 522 or the second optical receiver 524 are downstream channels having a designated wavelength (λ₁, λ₂, λ₃, . . . λ_{N}) or a second upstream channel, respectively.

A 1×N CWDM (Coarse Wavelength Division Multiplexer) is preferably used for the wavelength division multiplexer 530. In this arrangement, the downstream optical signal includes N/2 of the downstream signals.

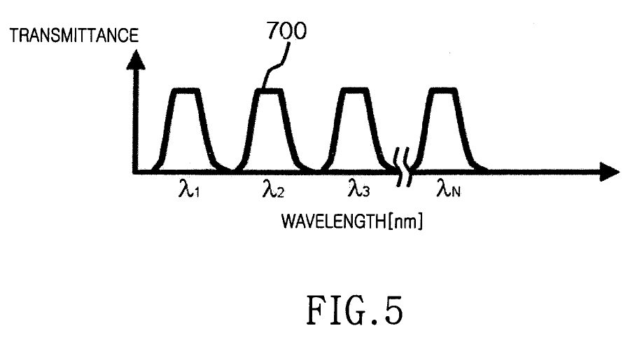

FIG. 5 is a diagram showing an output characteristic of the fiber transfer end 510 depicted in FIG. 4 at the output of the wavelength division multiplexer 530. As depicted in the drawing, output characteristic of the wavelength division multiplexer 530 is expressed in terms of transmittance per wavelength. In particular, the ups and downs of the transmittance plotted in the graph 700 of transmittance per wavelength are set to be repeated periodically, and the wavelength between the N downstream channels and the second upstream channels is blocked by the wavelength division multiplexer 530.

Referring to FIG. 4 again, a 1×2 wavelength division multiplexer (more preferably, a 1×2 CWDM including a thin filter) may be used for the optical divider 540. The optical divider 540 outputs downstream optical signals, which are inputted into a first port, to a third port, and outputs the first upstream channels among other upstream optical signals that are inputted to the third port through a second port, and outputs upstream signals composed of the second upstream channels exclusively to the first port. In this arrangement, the third port is connected to the fiber 555. The second upstream channels are included in the bidirectional wavelength band.

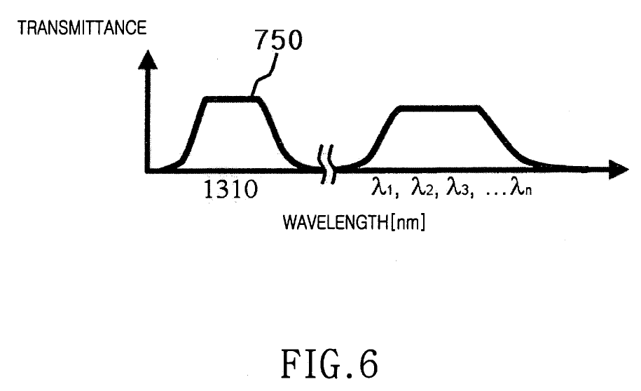

FIG. 6 is a diagram illustrating an output characteristic of the fiber transfer end 510 depicted in FIG. 4 at the output of the optical divider 540. More specifically, it is a graph 750 representing a relation between wavelength and transmittance of the optical divider 540. As shown in the graph, only wavelengths included in the upstream wavelength band and the additional bidirectional wavelength band are outputable from the optical divider 540.

Referring back to FIG. 4, the first optical receiver 550 includes a photodiode. The first optical receiver 550 converts a first upstream channel at a designated wavelength that has been input through the second port of the optical divider 540 to an electric signal. This converted signal is then output.

A 1×N power splitter is preferably used for the power splitter 560. The power splitter 560 performs a uniform power split on the downstream optical signals input through a first port that is connected to the fiber 555. The split optical signals are output through a plurality of second ports as N optical network elements 690. In addition, the power splitter 560 combines the first and the second upstream channels, which are inputted from the N optical network element 690 through the plurality of second ports, to the fiber through the first port.

Each optical network element 690 includes an optical divider (e.g., 580, 640), a wavelength division multiplexer (e.g., 590, 650), an optical transceiver (e.g., 600, 660), and a first optical transmitter (e.g., 620, 680).

The following describes regarding the Nth optical network element 630.

A 1×2 wavelength division multiplexer (more preferably, a 1×2 CWDM including a thin filter) may be used for the optical divider 640. The optical divider 640 combines the second upstream channels that are input through the first port to the first upstream channels that are inputted through the second port at the fiber 555, and outputs downstream optical signals inputted through the fiber 555 through the first port.

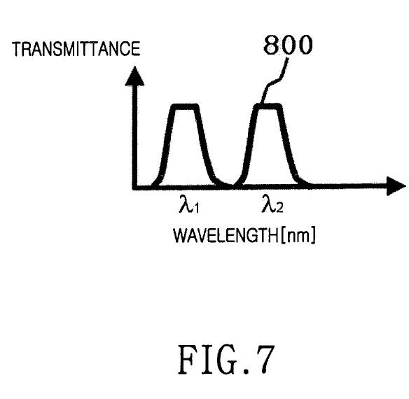

FIG. 7 is a diagram illustrating output characteristic of the Nth optical network element 630 depicted in FIG. 4 at the output of the Nth wavelength division multiplexer 650. FIG. 7 is a graph 800 showing a relation between transmittance and wavelength in the wavelength division multiplexer 650.

Referring back to FIG. 4, the optical transceiver 660 includes a second optical transmitter 674 and an optical receiver 672. the second optical transmitter 674 includes a laser diode and the optical receiver 672 includes a photodiode.

the first optical transmitter 680 includes a laser diode. The first optical transmitter 680 outputs a first upstream channel having a designated wavelength.

The following explains about the (N-1)th optical network element 570, and the same technologies will not be repeated.

A 1×N CMDM is may used for the wavelength division multiplexer 590. The wavelength division multiplexer 590 demultiplexes downstream optical signals that are received to the ports on the input side, and outputs the demultiplexed signals through the ports on the output side. In particular, the wavelength division multiplexer 590 outputs the first and the Nth downstream channels among other N/2 downstream channels composing the downstream optical signal.

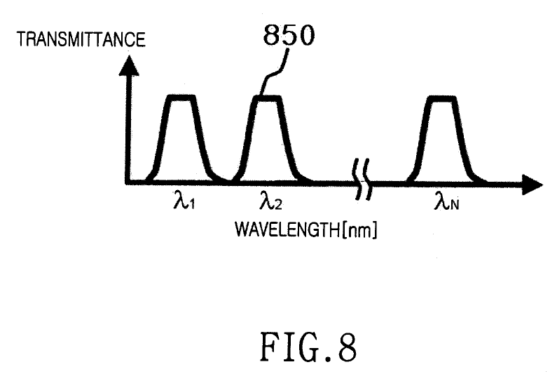

FIG. 8 is a diagram illustrating output characteristic of an (N-1)th optical network element depicted in FIG. 4 at the output of the (N-1)th wavelength division multiplexer 590. More specifically, FIG. 8 is a graph 850 showing a relation between transmittance and wavelength in the wavelength division multiplexer. As shown in FIG. 8, the wavelength division multiplexer 590 outputs the first and the Nth downstream channels among other downstream optical signals, and outputs the second upstream channel inputted from the second optical transmitter 614 to the optical divider 580.

In conclusion, the wavelength division multiplexing passive optical network system embodying the principles of the present invention is useful in many ways. For example, when bandwidth on the subscriber's side needs to be expanded, a laser diode and a photodiode used as part of the optical transmitter and the optical receiver in a corresponding optical network element may be simply added to the system. Moreover, the entire bandwidth can be expanded simply replacing an existing wavelength division multiplexer with the one having a larger transmission capacity, and adding more optical receivers and optical transmitters to the system.

As described above, the wavelength division multiplexing passive optical network system embodying the principles of the present invention is advantageous in that it can expand the bandwidth in use by applying the wavelength division multiplexing method to the downstream wavelength band.

In addition, the wavelength division multiplexing passive optical network system embodying the principles of the present invention is cost-effective by broadening the wavelength gap between downstream channels using the CWDM (Coarse Wavelength Division Multiplexer).

Lastly, the wavelength division multiplexing passive optical network system embodying the principles of the present invention is very useful when the transmission capacity needs to be expanded without changing the basis of the entire system because all that needs to be done is simply adding or replacing the number of elements in the system.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A wavelength division multiplexing passive optical network system, comprising:
a fiber transfer end for transmitting downstream optical signals through a fiber, the downstream optical signals are obtained by performing wavelength division multiplexing on downstream channels having different wavelengths from one another, and for demultiplexing upstream optical signals received through the fiber, the upstream optical signals include a first upstream channel and a second upstream channel, the first and second upstream channels having different wavelengths from one another;
a power splitter for performing a uniform power split on the downstream optical signals received through a first splitter port that is connected to the fiber, and for outputting the split optical signals through a plurality of second splitter ports, and for outputting upstream optical signals through the first splitter port, where the upstream optical signals are combination of the first and the second upstream channels received from the plurality of second splitter ports; and
a plurality of optical network elements for demultiplexing the downstream optical signals from the power splitter by wavelengths, and for transmitting the first and the second upstream channels to the power splitter.

2. The system defined in claim 1, wherein a wavelength of the first upstream channel is included in a wavelength band in a range of 1260 nm to 1360 nm, and wavelengths of downstream channels and the second upstream channels, plus an existing 1550 nm wavelength, are included in a wavelength band in a range of 1470 nm to 1610 nm.

3. The system defined in claim 2, wherein the wavelength of the first upstream channel is 1310 nm, and a wavelength gap between the downstream channels and the second upstream channels that are additionally defined is approximately 20 nm, centering around 1550 nm.

4. A wavelength division multiplexing passive optical network system including a plurality of optical network elements for transmitting at least one upstream channel and receiving at least one downstream channel, and a fiber transfer end connected to the plurality of optical network elements and to a fiber, wherein the fiber transfer end comprising:
a plurality of transmitters for outputting downstream channels each having a downstream designated wavelength;
a plurality of optical receivers for converting a first upstream channel or a second upstream channel each having a designated upstream wavelength to an electric signal;
a wavelength division multiplexer for outputting downstream optical signals, or the downstream channels on which wavelength division multiplexing is performed, and for demultiplexing upstream optical signals including the second upstream channels; and
an optical divider for combining the downstream optical signals, which are input from a first divider port, to the fiber, and for outputting the first upstream channel among other upstream optical signals, which are input through the fiber, through a second divider port, and for outputting an upstream optical signal including the second upstream channels only, to the first divider port.

5. The system defined in claim 4, wherein a wavelength of the first upstream channel is included in a wavelength band in a range of 1260 nm to 1360 nm, and wavelengths of downstream channels and the second upstream channels are included in a wavelength band in a range of 1470 nm to 1610 nm.

6. The system defined in claim 5, wherein the wavelength of the first upstream channel is 1310 nm, and a wavelength gap between the additional downstream channels and the second upstream channels is approximately 20 nm.

7. The system defined in claim 4, wherein the optical divider is a 1×2 coarse wavelength division multiplexer including a thin filter and fiber.

8. A wavelength division multiplexing passive optical network system including a fiber transfer end for receiving at least one upstream channel and for transmitting a plurality of downstream channels, and a plurality of optical network elements connected to the fiber transfer end and to a fiber, wherein each optical network element comprising:
a plurality of transmitters for outputting a first or a second upstream channel each having a designated wavelength;
an optical divider for performing wavelength division multiplexing on the second upstream channels that are input through a first divider port and a first upstream channel that is inputted through a second divider port, and for combining the wavelength division multiplexed channels to a fiber, and for outputting downstream optical signals, which are input through the fiber, through the first divider port;
a wavelength division multiplexer for demultiplexing the downstream optical signals, which are input through the first divider port, by wavelengths; and
a plurality of optical receivers for converting the wavelength division demultiplexed—downstream channels to electric signals.

9. The system defined in claim 8, wherein a wavelength of the first upstream channel is included in a wavelength band in a range of 1260 nm to 1360 nm, and wavelengths of downstream channels and the second upstream channels are included in a wavelength band in a range of 1470 nm to 1610 nm.

10. The system defined in claim 9, wherein the wavelength of the upstream channel is 1310 nm, and wavelength gap between the additional downstream channels and the second upstream channels is approximately 20 nm.

11. The system defined in claim 8, wherein the optical divider is a 1×2 coarse wavelength division multiplexer including a thin filter and fiber.
